(19) United States
(12) Patent Application Publication
(10) Pub. No.: US 2010/0026778 A1
(43) Pub. Date: Feb. 4, 2010

(54) DRAWING DEVICE AND METHOD, AND COMPUTER PROGRAM

(75) Inventor: Tetsuya Hayashi, Tokorozawa-shi (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/518,978

(22) PCT Filed: Dec. 15, 2006
(86) PCT No.: PCT/JP2006/325059

§ 371 Date: Sep. 1, 2009

(51) Int. Cl. B41J 2/435

(52) U.S. Cl. 347/224

(57) ABSTRACT

A drawing device (1) is provided with a drawing element (13) that irradiates laser light to a label surface of a recording medium to draw a desired pattern on the label surface, a first moving element (14) that moves a laser light irradiated position along an inner or outer circumferential direction of the recording medium by a first distance as a unit, a second moving element (131) that moves the laser light irradiated position along the inner or outer circumferential direction by a second distance that is shorter than the first distance as a unit, and a rearranging element (31, 32) that carries out the rearrangement of drawing data composing a desired pattern in accordance with a moving direction of the irradiated position that at least the second moving element moves, whereby the drawing element draws a desired pattern on the basis of the drawing data to be rearranged.

### TECHNICAL FIELD

The present invention relates to a drawing apparatus for and method of drawing a pattern such as a character or a letter, a graphic, and an image, for example, onto a label surface of a recording medium, and a computer program.

### BACKGROUND ART

An optical disc such as a CD and a DVD allows large volumes of data to be recorded thereon easily. As the data recorded on the optical disc for example, software, computer applications, computer files, video data, music data, and the like are listed as one specific example. Such an optical disc stores the data digitally. More specifically, a high-intensity laser beam is used to burn a small area of the optical disc (i.e. to change optical properties in the small area), so that a pit pattern according to the data to be recorded makes each small area reflective or unreflective. By this, it is possible to record the data onto the optical disc.

In recent years, in such an optical disc, a user's desired pattern (e.g. a desired image, character or letter, graphic, and the like) has been frequently drawn on a label surface, which is a surface on the opposite side of a recording surface on which the data is recorded. Typically, a simple action of using a pen or the like to draw the desired pattern and an action of using an ink jet printer to draw the desired pattern can be listed as one specific example.

On the other hand, as a technology of drawing the desired pattern, there has been developed a technology of laminating a pigmented film or the like on the label surface and applying a laser beam to the label surface (i.e. the pigmented film), thereby drawing the desired pattern onto the label surface (refer to patent documents 1 and 2). According to this technology, since the desired pattern can be drawn on the label surface using a hardware configuration for recording the data (specifically, an optical pickup or the like), it is possible to draw the clear image, character or letter, graphic, and the like on the label surface, relatively easily.
Patent document 1: U.S. Pat. No. 6,771,297
Patent document 2: Japanese Patent Application Laid Open No. 2006-511034

### DISCLOSURE OF INVENTION

### Subject to be Solved by the Invention

By the way, in the technology of drawing the desired pattern on the label surface, as described above, a drawing time is possibly sacrificed (i.e. the drawing time is prolonged) in order to ensure drawing quality. In particular, as opposed to the recording surface, the label surface does not have a track or the like which is an indication of radius information, so that the drawing time is more likely sacrificed.

In view of the aforementioned problems, it is therefore an object of the present invention to provide a drawing apparatus and method which can reduce the drawing time while ensuring the drawing quality in drawing the desired pattern onto the label surface, and a computer program for operating a computer as such a drawing apparatus.

### Means for Solving the Subject

The above object of the present invention can be achieved by a drawing apparatus provided with: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; a second displacing device for displacing the irradiation position in the inner circumferential direction or the outer circumferential direction, by a unit of a second distance which is shorter than the first distance; and a sorting device for performing a sorting processing for sorting drawing data on a plurality of tracks which constitute the desired pattern, by a track unit in accordance with a direction in which the irradiation position is displaced at least by the second displacing device, the drawing device drawing the desired pattern on the basis of the sorted drawing data.

The above object of the present invention can be also achieved by a drawing method in a drawing apparatus provided with: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; and a second displacing device for displacing the irradiation position in the inner circumferential direction or the outer circumferential direction, by a unit of a second distance which is shorter than the first distance, the drawing method provided with: a sorting process of performing a sorting processing for sorting drawing data on a plurality of tracks which constitute the desired pattern, by a track unit, in accordance with a direction in which the irradiation position is displaced at least by the second displacing device; and a controlling process of controlling the drawing device to draw the desired pattern on the basis of the sorted drawing data.

The above object of the present invention can be also achieved by a computer program for controlling a computer provided in a drawing apparatus provided with: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; a second displacing device for displacing the irradiation position in the inner circumferential direction or the outer circumferential direction, by a unit of a second distance which is shorter than the first distance; and a sorting device for performing a sorting processing for sorting drawing data on a plurality of tracks which constitute the desired pattern, by a track unit, in accordance with a direction in which the irradiation position is displaced at least by the second displacing device, the computer program making the computer function as at least the sorting device.

These operation and other advantages of the present invention will become more apparent from the embodiments explained below.

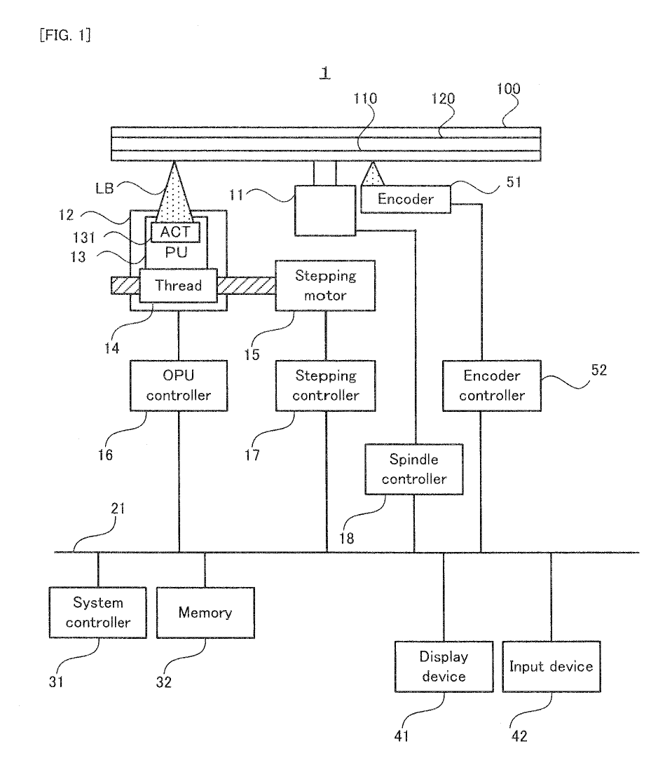

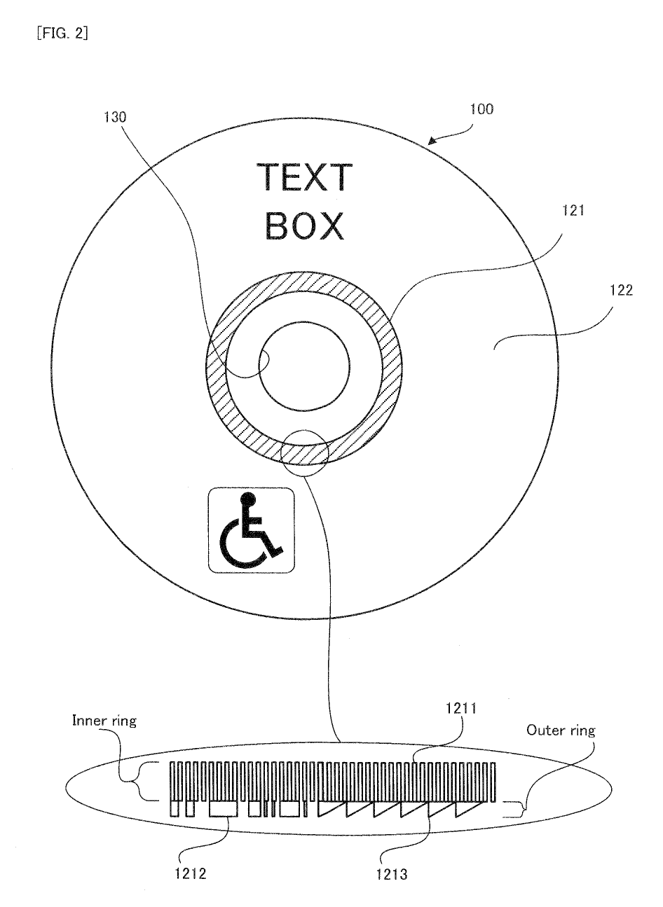

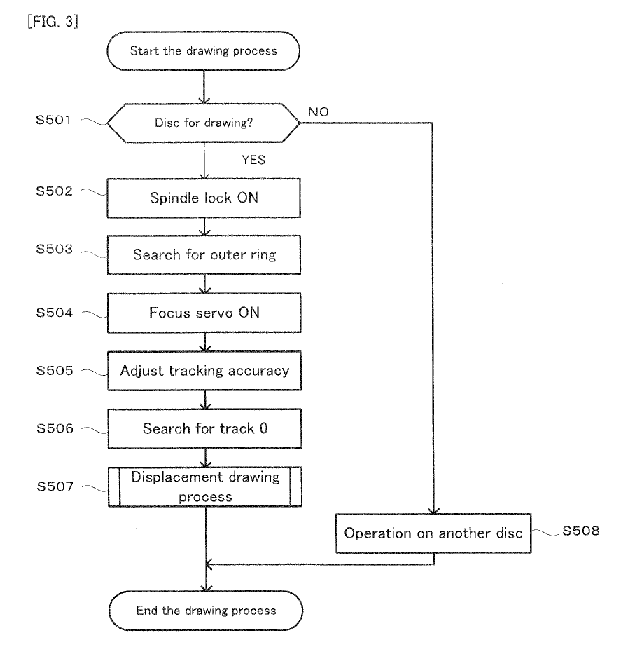

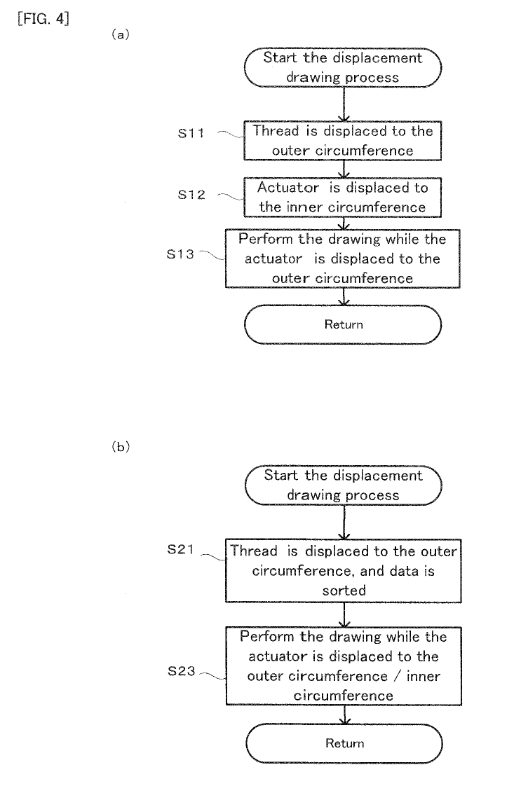

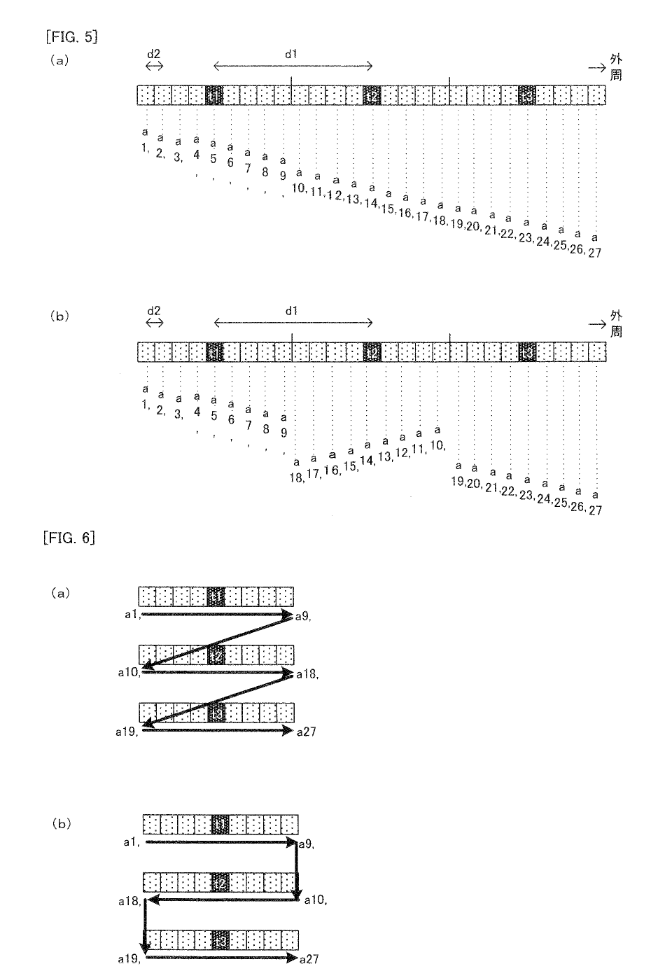

### BRIEF DESCRIPTION OF DRAWINGS

[FIG. 1] FIG. 1 is a block diagram conceptually showing the basic structure of a recording/reproducing apparatus in a first example.

[FIG. 2] FIG. 2 is a plan view showing the basic structure of an optical disc which is a target for the operations of the recording/reproducing apparatus in the first example. [FIG. 3] FIG. 3 is a flowchart conceptually showing a flow of a drawing process in the first example. [FIG. 4] FIG. 4 are flowcharts conceptually showing a flow of a displacement drawing process during the drawing process (a: a comparison example, b: the first example).

[FIG. 5] FIG. 5 are schematic diagrams schematically showing a drawing position and order in the displacement drawing process (a: the comparison example, b: the first example).

[FIG. 6] FIG. 6 are schematic diagrams schematically showing a position and order of an actuator in the displacement drawing process (a: the comparison example, b: the first example).

### DESCRIPTION OF REFERENCE CODES

1 information recording/reproducing apparatus
11 spindle motor
12 optical pickup unit
13 optical pickup
14 thread
15 stepping motor
51 encoder
52 encoder controller
16 OPU controller
17 stepping controller
18 spindle controller
21 data bus
31 system controller
32 memory
41 display device
42 input device
100 optical disc
110 data recording layer
120 label layer
121 characteristic data recording area
122 label area
1211, 1212, 1213 pattern

### BEST MODE FOR CARRYING OUT THE INVENTION

Hereinafter, as the best mode for carrying out the present invention, an explanation will be given on embodiments of the drawing apparatus and method, and the computer program of the present invention.

### Embodiment of Drawing Apparatus

An embodiment of the drawing apparatus of the present invention is a drawing apparatus provided with: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; a second displacing device for displacing the irradiation position in the inner circumferential direction or the outer circumferential direction, by a unit of a second distance which is shorter than the first distance; and a sorting device for performing a sorting process for sorting drawing data on a plurality of tracks which constitute the desired pattern, by a track unit, in accordance with a direction in which the irradiation position is displaced at least by the second displacing device, the drawing device drawing the desired pattern on the basis of the sorted drawing data.

According to this aspect, as detailed later, in drawing the desired pattern onto the label surface, it is possible to reduce a drawing time while ensuring drawing quality.

Firstly, this drawing apparatus is a drawing apparatus for performing a drawing process for drawing the desired pattern (e.g. a desired image, a desired character or letter, a desired graphic, and the like) onto the label surface (typically, a surface opposite to a recording surface, of the both surfaces of an optical disc) provided for the recording medium (e.g. an optical disc such as a CD, a DVD, and a BD), by receiving the desired pattern from a user or the like through an input device (e.g. a mouse, a keyboard, a touch panel, or the like).

The aforementioned desired pattern is drawn onto the label surface by the drawing device (e.g. an optical pickup having a semiconductor laser device, a lens, and the like) applying the laser beam to the label surface. Specifically, the drawing device can be displaced, for example, in a radial direction of the recording medium (in other words, a tracking direction) along the label surface. Moreover, for example, a pigmented film or the like is applied on the label surface, and the desired pattern is drawn on the label surface by using a difference between the reflectance of the pigmented film in a portion that is irradiated with the laser beam and the reflectance of the pigmented film in a portion that is not irradiated with the laser beam.

The irradiation position of the laser beam applied in the above manner is displaced (typically, each drawing device) by the first displacing device (e.g. a thread driven by a stepping motor) in the inner circumference direction or the outer circumferential direction of the recording medium, by a unit of the first distance. Here, the irradiation position includes not only a spot position in a case where the spot is formed by applying the laser beam but also a position at which the spot is expected to be formed if the laser beam is applied even if it is not irradiated. The first distance is, for example, 300□m, and it is a distance corresponding to one step of a stepping motor.

The aforementioned irradiation position is further displaced by the second displacing device (e.g. an actuator provided for an optical pickup) in the inner circumferential direction or the outer circumferential direction of the recording medium, by a unit of the second distance which is shorter than the first distance (typically, by rearranging an optical system such as a lens provided for the drawing device). Here, the second distance is, for example, 30 μm which is shorter than 300 μm, and it is a distance according to the resolution of an actuator, an interval of tracks on which the drawing is performed, and the like.

In other words, the label surface of the recording medium does not have a track or the like which is an indication of radius information, so that the aforementioned drawing device is roughly displaced by the first displacing device and is finely displaced by the second displacing device, for example, with a basic point at a radial position obtained from information recorded in an embossed area on the inner circumferential side of the label surface.

Simultaneously with or in tandem with the displacement of the drawing device in this manner, the sorting processing is performed by the sorting device (e.g. a system controller and a memory). In other words, in accordance with the direction in which the irradiation position is displaced at least by the second displacing device, the drawing data (e.g. image data such as bitmap and vector data) on the plurality of tracks (which are, for example, arranged concentrically or spirally on the label surface) which constitute the desired pattern are sorted by the track unit. Here, “by the track unit” in effect indicates that it is the drawing order of each track that is to be sorted in accordance with the direction in which the irradiation position is displaced out of the drawing data, and that sorting the drawing data which belongs to each track is not included; provided, however, that this shall not apply to a case where it is caused by another factor such as a search time between the tracks.

On the basis of the drawing data sorted in this manner, the desired pattern is drawn by the drawing device, typically, every time the irradiation position is displaced by the second displacing device. Therefore, even if the direction in which the first displacing device and the second displacing device are displaced is any of the inner circumferential direction and the outer circumferential direction, or even if the both directions are mixed, it is possible to appropriately draw the desired pattern. In other words, the purpose is realized by changing the drawing order by using intermittent drawing in each one track without being bounded by the drawing from the inner circumference, focusing on that the displacement by the second displacing device is limited or controlled as much as possible.

In the case of the drawing on the label surface without the aforementioned sorting device, the desired pattern is generally drawn in good order in any one of the inner circumferential direction and the outer circumferential direction. For example, in order to perform the drawing in good order in the outer circumferential direction, the desired pattern is drawn only when the aforementioned irradiation position is roughly displaced by the first displacing device in the outer circumferential direction and is finely displaced by the second displacing device in the outer circumferential direction. In order to draw the desired pattern onto the entire label surface in this manner, the irradiation position needs to be returned by the second displacing device in the inner circumferential direction (e.g. to the innermost position of a movable range by the second displacing device). However, if the irradiation position is displaced from the outer circumference to the inner circumference in one movement at this time, the drawing device (in particular, a lens through which the laser beam is transmitted) is oscillated due to no feedback control, and it may cause a reduction in the drawing quality. In order to avoid the reduction in the drawing quality, if a wait time is introduced to statically determine the drawing device until the next drawing is started, the wait time is required at each time of the displacement by the first or second displacing device, and it takes 140 times×300 μsec=about 42 see to completely perform the drawing on one optical disc.

However, according to the embodiment of the drawing device of the present invention, since the sorting device as described above is provided, it is possible to draw the desired pattern in each direction of the inner and outer circumferential directions. For example, even if the irradiation position is returned by the second displacing device in the inner circumferential direction, the drawing data corresponding to this portion can be sorted in opposite order and drawn. Therefore, it is possible to significantly reduce the wait time, thereby allowing faster drawing. In particular, the wait time does not change in any recording mode, so it is expected to reduce the time by about 2 to 8% by the drawing setting. In addition, since the maximum displacement of the irradiation position is reduced, the magnitude of oscillation is limited or controlled even in the setting of the wait time insufficient to be completely statically determined, thereby reducing the decline of drawing quality.

As can be seen above, according to the embodiment of the drawing device of the present invention, in drawing the desired pattern onto the label surface, it is possible to reduce the drawing time while ensuring the drawing quality, and it is extremely useful in practice.

In one aspect of the embodiment of the drawing apparatus of the present invention, if the first displacing device displaces the irradiation position in any one (e.g. the outer circumferential direction) of the inner circumferential direction and the outer circumferential direction, the drawing device draws the desired pattern even when the second displacing device displaces the irradiation position in the other direction (e.g. the inner circumferential direction).

According to this aspect, it is possible to reduce the drawing time. More specifically, in order to draw the desired pattern onto the entire label surface, it is necessary to repeatedly perform the displacement by the first and second displacing devices. Along with that, the irradiation position once displaced by the second displacing device in the outer circumferential direction is frequently displaced in the inner circumferential direction in order to return it to the original inner circumferential side. Even in this case, since the sorting processing is performed by the sorting device, the drawing device can draw the desired pattern. In this manner, a wasteful motion without the drawing is reduced, so that it is possible to reduce the drawing time.

In this aspect, the sorting device performs the sorting processing such that of the plurality of tracks, a track drawn in a case where the irradiation position is displaced by the second displacing device in the other direction (e.g. the inner circumferential direction) is drawn in opposite order of a case where the track is displaced in the one direction (e.g. the outer circumferential direction).

According to this aspect, if the direction in which the irradiation position is displaced is reversed, the drawing data is also reversed or sorted in opposite order. Thus, it is possible to avoid an error in the drawing order while reducing the drawing time.

In another aspect of the embodiment of the drawing apparatus of the present invention, the first displacing device is driven by a multiphase (e.g. two-phase) stepping motor.

According to this aspect, the first displacing device is driven by the multiphase stepping motor which can manage a travel distance on the basis of the number of input pulses or the like. Thus, even if the label surface of the recording medium does not have a track or the like which is an indication of radius information, it is possible to ensure displacement accuracy. At this time, if the two-phase stepping motor is driven at a two-phase driving position, the accuracy is improved since a magnetic force at the two-phase driving position is stronger than at other positions. The other positions can be interpolated by a second driving device with higher resolution, so that it is also possible to avoid a reduction in resolution.

In another aspect of the embodiment of the drawing apparatus of the present invention, the sorting device performs the sorting processing while the first displacing device displaces the irradiation position.

According to this aspect, it is possible to reduce the drawing time. More specifically, at the stage that the first displacing device displaces the irradiation position, it is specified in which direction the second displacing device displaces the irradiation position next, on the basis of a status of the second displacing device (e.g. in which of the inner circumferential direction and the outer circumferential direction it remains to be displaced). Therefore, if the sorting processing is performed during that time, it is possible to reduce the drawing time. Incidentally, the sorting processing may be performed in advance on an application side which receives the starting point of the displacement by the second displacing device.

### Embodiment of Drawing Method

An embodiment of the drawing method of the present invention is a drawing method in a drawing apparatus provided with: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; and a second displacing device for displacing the irradiation position in the inner circumferential direction or the outer circumferential direction, by a unit of a second distance which is shorter than the first distance, the drawing method provided with: a sorting process of performing a sorting processing for sorting drawing data on a plurality of tracks which constitute the desired pattern, by a track unit, in accordance with a direction in which the irradiation position is displaced at least by the second displacing device; and a controlling process of controlling the drawing device to draw the desired pattern on the basis of the sorted drawing data.

The embodiment of the drawing method of the present invention can receive the same various effects as those that can be received by the aforementioned embodiment of the drawing apparatus of the present invention.

Incidentally, in response to the aforementioned various aspects in the embodiment of the drawing apparatus of the present invention, the embodiment of the drawing method of the present Invention can also adopt various aspects.

### Embodiment of Computer Program

An embodiment of the computer program of the present invention is a computer program for controlling a computer provided in a drawing apparatus provided with: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; a second displacing device for displacing the irradiation position in the inner circumferential direction or the outer circumferential direction, by a unit of a second distance which is shorter than the first distance; and a sorting device for performing a sorting processing for sorting drawing data on a plurality of tracks which constitute the desired pattern, by a track unit, in accordance with a direction in which the irradiation position is displaced at least by the second displacing device, the computer program making the computer function as at least the sorting device.

According to the embodiment of the computer program of the present invention, the aforementioned embodiment of the drawing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the aforementioned various aspects in the embodiment of the drawing apparatus of the present invention, the embodiment of the computer program of the present invention can also adopt various aspects.

An embodiment of the computer program product of the present invention makes the computer function as at least the sorting device.

According to the embodiment of the computer program product of the present invention, the aforementioned embodiment of the drawing apparatus of the present invention can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the drawing apparatus of the present invention.

Incidentally, in response to the aforementioned various aspects in the embodiment of the drawing apparatus of the present invention, the embodiment of the computer program product of the present invention can also adopt various aspects.

These operation and other advantages of the present invention will become more apparent from the example explained below.

As explained above, according to the embodiment of the drawing apparatus of the present invention, it is provided with the drawing device, the first displacing device, the second displacing device, and the sorting device. According to the embodiment of the drawing method of the present invention, it is provided with the sorting process and the controlling process. According to the embodiment of the computer program of the present invention, it makes a computer function as at least the sorting device. Therefore, in drawing the desired pattern onto the label surface, it is possible to reduce the drawing time while ensuring the drawing quality.

### EXAMPLE

Hereinafter, an example of the present invention will be explained with reference to the drawings. Incidentally, the following example is explained by using the construction that the drawing apparatus or the like of the present invention is applied to an information recording/reproducing apparatus for an optical disc.

### (1) First Example

### (1-1) Basic Structure

Firstly, with reference to FIG. 1 and FIG. 2, an explanation will be given on the basic structures of an information recording/reproducing apparatus in a first example and an optical disc which is a target for the operations by the information recording/reproducing apparatus. FIG. 1 is a block diagram conceptually showing the basic structure of the recording/reproducing apparatus in the first example. FIG. 2 is a plan view showing the basic structure of the optical disc which is a target for the operations of the recording/reproducing apparatus in the first example.

As shown in FIG. 1, an information recording/reproducing apparatus 1 in the example is provided with a spindle motor 11, an optical pickup (OPU) unit 12, an optical pickup 13, a thread 14, a stepping motor 15, an encoder 51, a display device 41, an input device 42, an OPU controller 16, a stepping controller 17, a spindle controller 18, a system controller 31, and a memory 32.

The spindle motor 11 is a motor for rotating and stopping an optical disc 100. More specifically, the spindle motor 11 is adapted to rotate the optical disc 100 at a predetermined speed and stop it, under spindle servo under the control of the spindle controller 18.

The optical pickup unit 12 constitutes one specific example of the “drawing device” of the present invention. The optical pickup unit 12 is a case for holding the optical pickup 13 and the thread 14.

The thread 14 constitutes one specific example of the “first displacing device” of the present invention. The thread 14 is subjected to a driving force by the stepping motor 15 and is displaced in a radial direction of the optical disc 100 with the optical pickup unit 12.

The optical pickup 13 is provided with, for example, a semiconductor laser device, a collimator lens, a light receiving element, an objective lens, which are not illustrated, and an actuator 131 or the like capable of oscillating a lens holder for the objective lens with respect to a plurality of axes, in order to perform data recording and reproduction on the optical disc 100. Here, the actuator 131 constitutes one specific example of the “second displacing device” of the present invention. In the optical pickup 13, the position in the radial direction of the optical disc 100 is adjusted by the displacement of the thread 14 by the stepping motor 15, and the position is further finely adjusted by the actuator 131 disposed in the optical pickup unit 12. In other words, the position of the optical pickup 13 is determined by the displacement of the thread 14 by the stepping motor 15, and then, the irradiation position of a laser beam LB is determined by the actuator 131 which can move with higher resolution. At this time, in order to improve the displacement accuracy of the thread 14, the displacement may be performed using only a two-phase displacement position which has a high magnetic force. Moreover, the optical pickup 13 applies the laser beam LB to the optical disc 100 as reading light with a first power in the reproduction, and as writing light with a second power with it modulated in the recording. In addition, the optical pickup 13 applies the laser beam LB to the optical disc 100 in performing label drawing on the optical disc 100.

The stepping motor 15 constitutes one specific example of the “first displacing device” of the present invention with the thread 14. The stepping motor 15 displaces the thread 14 in the radial direction of the optical disc 100, in accordance with a voltage applied by the stepping controller 17.

The encoder 51 applies a laser beam to a characteristic data recording area 121 (refer to FIG. 2) of the optical disc 100 under the control of an encoder controller 52, and it receives the reflected light by a light receiving element, thereby obtaining velocity information and angle information about the optical disc 100.

The display device 41 has, for example, a liquid crystal display or a plasma display or the like, and it functions as a user interface in performing the label drawing.

The input device 42 is a tablet-type display unified with, for example, a keyboard, a mouse, or the display device 41. The input device 42 receives various inputs such as information for forming a desired pattern (e.g. a character or letter, a command, coordinate information), from a user. The received input is transmitted to the system controller 31 through the data bus 21. In accordance with the content, the desired pattern displayed on the display device 41 is changed, or a predetermined operation process is performed by the information recording/reproducing apparatus 1.

The OPU controller 16 is provided with, for example, a laser diode driver or the like, and it controls an operation of applying the laser beam LB by the optical pickup 13. Specifically, the OPU controller 16 controls the power, irradiation timing, irradiation position and the like of the laser beam LB (in other words, the operations of the optical pickup 13) in cooperation with the stepping controller 17, the spindle controller 18, and the encoder controller 52, under the control of the system controller 31.

The stepping controller 17 controls the voltage to be applied to the stepping motor 15, thereby controlling the displacement or travel distance of the thread 14 by the stepping motor 15. Specifically, the stepping controller 17 controls the displacement of the thread 14 (in other words, the operations of the stepping motor 15) in cooperation with the OPU controller 16 and the spindle controller 18, under the control of the system controller 31.

The spindle controller 18 controls the rotation of the optical disc 100 by the spindle motor 11. Specifically, the spindle controller 18 controls the rotational speed, rotational angle, or the like of the optical disc 100 (in other words, the operations of the spindle motor 11) in cooperation with the OPU controller 16 and the stepping controller 17, under the control of the system controller 31.

The system controller 31 constitutes one specific example of the “sorting device” of the present invention. The system controller 31 is connected to the display device 42, the input device 41, the OPU controller 16, the stepping controller 17, the spindle controller 18, and the memory 32 through the data bus 21. The system controller 31 outputs a control command to each of the OPU controller 16, the stepping controller 17, and the spindle controller 18, thereby controlling the entire information recording/reproducing apparatus 1. Moreover, the system controller 31 allows the display device 41 to display a motion picture (in particular, the desired pattern) based on the input information from the input device 42 and the memory 32 to store the input device therein. Normally, software or firmware for the system controller 31 operating is stored in the memory 32.

The memory 32 is provided with a ROM area which stores therein a program for the information recording/reproducing apparatus 1 operating (i.e. firmware); a RAM area which temporarily stores therein data used during the operations by the information recording/reproducing apparatus 1; and the like.

Incidentally, the optical disc 100, which is the target for the operations of the recording/reproducing apparatus in the example, has a circular shape as in a DVD, for example, as shown in FIG. 1 and FIG. 2, and the optical disc 100 has a recording layer 110 laminated on one side and a label layer 120 laminated on the other side. The data recording layer 110 is irradiated with the laser beam LB from the lower side in FIG. 1, by which the data is recorded and reproduced. On the other hand, the label layer 120 is irradiated with the laser beam LB from the upper side in FIG. 1, by which the label is drawn.

The data recording layer 110 of the optical disc 100 is provided with, for example, a pigmented film or a phase change film whose properties (e.g. reflective properties) are changed by the irradiation of the laser beam LB. The data recording layer 110 is provided with a lead-in area, a user data area, and a lead-out area, centered on a center hole 130 (refer to FIG. 2). The data recording layer 110 also has a track such as a groove track and a land track, alternately placed spirally or concentrically, centered on the center hole 130. Moreover, on the track, the data is divided and recorded by a unit of ECC block. The ECC block is a data management unit by which the data can be error-corrected.

On the other hand, the label layer 120 of the optical disc 100 is provided with, for example, a pigmented film whose properties (e.g. reflective properties) are changed by the irradiation of the laser beam LB. The label layer 120 is not provided with the aforementioned track; however, obviously it may be also provided with the track. The label layer 120 is provided particularly with a characteristic data recording area 121 on the innermost side and a label area 122 in which the label (i.e. one specific example of the “desired pattern” of the present invention) is actually drawn on the outer side of the characteristic data recording area 121.

The characteristic data recording area 121, as shown in the enlarged view thereof shown on the lower side in FIG. 2, has a pattern 1211 formed, in which a rectangular pattern that has a high optical reflectance and a rectangular pattern that has the same size as the rectangular pattern with a high optical reflectance and that has a low optical reflectance are regularly arranged. The pattern 1211 is read by the encoder 51. The pattern 1211 enables the information recording/reproducing apparatus 1 to obtain information about the velocity of the optical disc 100 (specifically, angular velocity or rotational speed), in performing the label drawing into the label area 122. By this, the information recording/reproducing apparatus 1 can adjust or recognize the velocity of the optical disc 100 in performing the label drawing into the label area 122.

The characteristic data recording area 121, as shown in the enlarged view thereof shown on the lower side in FIG. 2, also has a pattern 1212 formed, in which a rectangular pattern that has a high optical reflectance and a rectangular pattern that has a low optical reflectance are irregularly arranged. In particular, each of the rectangular pattern with a high optical reflectance and the rectangular pattern with a low optical reflectance has various sizes depending on a position at which each of the rectangular patterns is formed. The pattern 1212 enables the information recording/reproducing apparatus 1 to obtain information about the angle direction of the rotating optical disc 100 (i.e. a direction in which such a line is directed that extends from the center of the optical disc 100 toward a predetermined point in the surrounding of the disc). By this, the information recording/reproducing apparatus 1 can adjust or recognize the angle of the optical disc 100 in performing the label drawing into the label area 122.

The characteristic data recording area 121, as shown in the enlarged view thereof shown on the lower side in FIG. 2, also has a pattern 1213 formed, in which a saw-teeth pattern that has a high optical reflectance and a rectangular pattern that is disposed oppositely to the saw-teeth pattern with a high optical reflectance and that has a low optical reflectance are regularly arranged. The pattern 1213 enables the information recording/reproducing apparatus 1 to adjust the position of the optical pickup 13) in the radial direction of the optical disc 100, highly accurately. In other words, it is possible to adjust the tracking accuracy of the optical pickup 13 by the actuator 131.

More specifically, a duty ratio of the reflective light of the laser beam LB applied to the pattern 1213 allows the adjustment of the tracking accuracy of the optical pickup unit 12. When a predetermined voltage is applied to the actuator 131, the displacement of the optical pickup 13 from a position at which the duty ratio is 50% (i.e. the central position in the radial direction of the pattern 1213) is detected on the basis of the duty ratio. This operation is repeated while the voltage applied to the actuator 131 is changed. By this, it is possible to obtain a correlation between the voltage applied to the actuator 131 and the displacement of the optical pickup 13. After that, the obtained correlation is used to adjust the position of the optical pickup 13 in performing the label drawing into the label area 122.

Incidentally, the pattern 1211 formed on the relatively inner side is referred to as an inner ring. The inner ring is formed in an area with radius positions of 19.00 mm to 21.15 mm on the optical disc 100. On the other hand, the patterns 1212 and 1213 formed on the relatively outer side are referred to as an outer ring. The outer ring is formed in an area with radius positions of 21.15 mm to 21.80 mm on the optical disc 100. Each pattern formed in the characteristic data recording area 121 may be read by the information recording/reproducing apparatus 1 while the label is drawn into the label area 122, or each pattern may be read before the label is drawn into the label area 122. Each pattern may be also formed by a silk screen printing method or another method.

In the label area 122, as shown on the upper side in FIG. 2, a user's desired label (e.g. a character or letter, graphic, image, or the like) can be drawn. The desired label is drawn as a so-called black-and-white pattern, using a difference between the optical reflectance in the small area that is irradiated with the laser beam LB and the optical reflectance in the small area that is not irradiated with the laser beam LB.

### (1-2) Operation Principle

Next, with reference to FIG. 3 to FIG. 6, an explanation will be given on the operations (in particular, the drawing operation into the label layer 120) by the information recording/reproducing apparatus 1 in the example.

Firstly, with reference to FIG. 3 in addition to FIG. 1 and FIG. 2, an explanation will be given on a specific operation process of the label drawing. FIG. 3 is a flowchart conceptually showing a flow of the drawing process in the first example.

In FIG. 3, firstly it is judged whether or not the optical disc loaded on the information recording/reproducing apparatus 1 is the optical disc 100 on which the label drawing can be performed by the information recording/reproducing apparatus 1 (i.e. the aforementioned optical disc 100 in the example), under the control of the system controller 31 (step S501).

As a result of the judgment in the step S501, if it is judged that the optical disc loaded on the information recording/reproducing apparatus 1 is not the optical disc 100 on which the label drawing can be performed by the information recording/reproducing apparatus 1 (the step S501: No), operations in a step S502 to a step S507 which will be explained below are not performed, and an operation according to the loaded optical disc is performed (step S508).

On the other hand, as a result of the judgment in the step S501, if it is judged that the optical disc loaded on the information recording/reproducing apparatus 1 is the optical disc 100 on which the label drawing can be performed by the information recording/reproducing apparatus 1 (the step S501: Yes), then the spindle motor 11 is locked under the control of the spindle controller 18 (step S502). Specifically, the inner ring including the aforementioned pattern 1211 is read, and the rotational speed of the spindle motor 11 (in other words, the rotational speed of the optical disc 100) is adjusted in accordance with the reading result. After that, the rotational speed of the spindle motor 11 is kept constant.

Then, after the outer ring including the aforementioned patterns 1212 and 1213 is searched for (step S503), focus servo is turned ON (step S504).

Then, the outer ring searched for in the step S503 is used to adjust a tracking accuracy (step S505).

Then, a track 0 which is a position to start the drawing of the desired label into the label area 122 is searched for (step S506). The label layer 120 does not have a physical track, so the track 0 is virtual; however, for example, it exists in a position with a radial position of 23.80±0.03 mm on the optical disc 100.

Then, the desired label is drawn into the label area 122 by a displacement drawing process including a sorting process in the example (step S507).

Now, the aforementioned displacement drawing process will be explained while comparing a compassion example and the first example with reference to FIG. 4 to FIG. 6. FIG. 4 are flowcharts conceptually showing a flow of the displacement drawing process during the drawing process (a: a comparison example, b: the first example). FIG. 5 are schematic diagrams schematically showing a drawing position and order in the displacement drawing process (a: the comparison example, b: the first example). FIG. 6 are schematic diagrams schematically showing a position and order of an actuator in the displacement drawing process (a: the comparison example, b: the first example).

Now, with regard to the irradiation position of the laser beam LB, it is assumed that a unit distance of the displacement by the thread 14 (i.e. a distance corresponding to one step of the stepping motor 15) is d1 (e.g. 300 μm), that a unit distance of the displacement by the actuator 131 is d2 (e.g. 30 μm), that displacement order of the thread 14 in the radial direction of the optical disc 100 is tn (n=1, 2, 3, and so on), and that displacement order of the actuator 131 in the radial direction of the optical disc 100 is an (n=1, 2, 3, and so on). Moreover, in any of the comparison example and the first example shown in FIG. 5(a) and FIG. 5(b) and FIG. 6(a) and FIG. 6(b), basically the position of the optical pickup 13 (e.g. t1) is determined by the displacement of the thread 14 by the stepping motor 15, and then, the irradiation position of the laser beam LB (e.g. a1, a2, a3, and so on) is determined by the actuator 131 which can move with higher resolution (i.e. d1>d2). The main difference between the comparison example and the first example is the displacement order and the direction of displacement of the actuator 131, as detailed later.

In the comparison example shown in FIG. 4(a), FIG. 5(a), and FIG. 6(a), the displacement drawing process is performed as follows. For example, if the position of the optical pickup 13 is t1, the irradiation position of the laser beam LB is sent in order of a1, a2, a3, . . . , and a9 by the displacement in the outer circumferential direction of the actuator 131, and the laser beam LB is applied at each irradiation position on the basis of drawing data (step S13). Then, the position of the optical pickup 13 is displaced to t2 by the displacement in the outer circumferential direction of the thread 14 (step S11). Here, in particular, in order to perform the drawing from the inner circumference to the outer circumference in good order, the actuator 131. once returns to the inner circumference (step S12). Then, the irradiation position of the laser beam LB is sent in order of a10, a11, a12, . . . , and a18 by the displacement in the outer circumferential direction of the actuator 131, and the laser beam LB is applied at each irradiation position on the basis of the drawing data (the step S13). After that, a case where the position of the optical pickup 13 is t3 is the same as the case of t2, and this series of processes is continued until the displacement to the outermost circumference or the end of the drawing.

On the other hand, in the first example shown in FIG. 4(b), FIG. 5(b), and FIG. 6(b), the displacement drawing process is performed as follows. For example, if the position of the optical pickup 13 is t1, the irradiation position of the laser beam LB is sent in order of a1, a2, a3, . . . , and a9 by the displacement in the outer circumferential direction of the actuator 131, and the laser beam LB is applied at each irradiation position on the basis of the drawing data (step S23). So far, the processes are the same as in the comparison example. However, the first example particularly allows the drawing while being displaced in the outer circumferential direction and the drawing while being displaced in the inner circumferential direction to be mixed, to the effect that it is not always necessary to perform the drawing from the inner circumference to the outer circumference in good order if the same desired pattern can be drawn. Thus, the sorting process is performed. In other words, the position of the optical pickup 13 is displaced to t2 by the displacement in the outer circumferential direction of the thread 14, and the data arranged to perform the drawing in the outer circumferential direction is sorted to perform the drawing in the inner circumferential direction (i.e. in order of a10, a11, a12, . . . , and a18) (step S21). More specifically, normally several tens of tracks of data are stored in a buffer (the memory 32) of a drive (the information recording/reproducing apparatus 1). Thus, by sorting the track order of the data in the drive in accordance with the control of the actuator 131, it is possible to draw the desired pattern without change. Moreover, if the starting points of the operations of the actuator 131 are returned to an application outside the information recording/reproducing apparatus 1, the same operations can be performed by forwarding a drawing radial position and the drawing data on the application side in accordance with the operation timing of the drive. As described above, if the drawing data is sorted, then, the irradiation position of the laser beam LB is sent in order of a10, a11, a12, . . . , and a18 by the displacement in the inner circumferential direction of the actuator 131, and the laser beam LB is applied at each irradiation position on the basis of the drawing data (the step S23). After that, the case where the position of the optical pickup 13 is t3 is the same as the case of t2, and this series of processes is continued until the displacement to the outermost circumference or the end of the drawing. More specifically, if 30 μm is 1 track, first, a lens position is sent to an inner circumferential position of 150 μm, and then it is displaced by the actuator by 30 μm from there. When the lens is displaced to an outer circumferential position of 150 μm due to the displacement by 300 μm, the lens position is sent again to the inner circumferential position of 150 μm by displacing the thread by 300 μm, and the drawing is performed again.

As explained above, in the first example, as opposed to the comparison example, the actuator 131 does not return to the inner circumference without the irradiation of the laser beam LB. In other words, focusing on that it is not always necessary to perform the drawing from the inner circumference to the outer circumference in good order in drawing the desired pattern, a wasteful motion is reduced as much as possible by sorting the data as occasion demands in the first example. As a result, the following effects are obtained.

Firstly, since the maximum displacement of the actuator 131 is reduced, it is possible to significantly reduce a wait time, thereby allowing faster drawing. For example, since the large displacement of the actuator can be eliminated, the wait time can be set to about 50 μsec as an example, which makes the drawing time faster by 140 times×250 μsec=about 35 sec. In particular, the wait time does not change in any recording mode, so it is expected to reduce the time by about 2 to 8% by the drawing setting. Secondly, since the maximum displacement of the actuator 131 is reduced, the magnitude of oscillation is limited or controlled even in the wait time insufficient to be completely statically determined, thereby reducing the decline of drawing quality. Thirdly, since only the displacement direction of the actuator 131 and the sorting or arrangement of the drawing data are changed, the response on the application side is not required, and they can be realized in the process in the drive (i.e. the information recording/reproducing apparatus 1). In short, despite the relatively simple construction, it is possible to reduce the drawing time while ensuring the drawing accuracy.

Moreover, the aforementioned example is explained with a light scribe technology in mind; however, it is obviously possible to receive the aforementioned effects by adopting the aforementioned construction in various applications such as other technologies for drawing the label (e.g. label flash, DiscT@2).

The present invention is not limited to the aforementioned example, but various changes may be made, if desired, without departing from the essence or spirit of the invention which can be read from the claims and the entire specification. A drawing apparatus and method, and a computer program, all of which involve such changes, are also intended to be within the technical scope of the present invention.

### INDUSTRIAL APPLICABILITY

The drawing apparatus and method and the computer program of the present invention can be applied to an information recording apparatus such as a DVD recorder, which can draw a pattern such as a character or a letter, a graphic, and an image, onto a label surface of a recording medium such as a DVD. Moreover, they can be also applied to an information recording apparatus or the like which is mounted on or connected to various computer equipment for consumer use or for commercial use.

1. A drawing apparatus comprising:
a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; a second displacing device for displacing the irradiation position in the inner circumferential direction or the outer circumferential direction, by a unit of a second distance which is shorter than the first distance; and a sorting device for performing a sorting processing for sorting drawing data on a plurality of tracks which constitute the desired pattern, by a track unit, in accordance with a direction in which the irradiation position is displaced at least by said second displacing device, said drawing device drawing the desired pattern on the basis of the sorted drawing data.

2. The drawing apparatus according to claim 1, wherein if said first displacing device displaces the irradiation position in any one of the inner circumferential direction and the outer circumferential direction, said drawing device draws the desired pattern even when said second displacing device displaces the irradiation position in the other direction.

3. The drawing apparatus according to claim 2, wherein said sorting device performs the sorting processing such that of the plurality of tracks, a track drawn in a case where the irradiation position is displaced by said second displacing device in the other direction is drawn in opposite order of a case where the track is displaced in the one direction.

4. The drawing apparatus according to claim 1, wherein said first displacing device is driven by a multiphase stepping motor.

5. The drawing apparatus according to claim 1, wherein said sorting device performs the sorting processing while said first displacing device displaces the irradiation position.

6. A drawing method in a drawing apparatus comprising: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; and a second displacing device for displacing the irradiation position in the inner circumferential direction or the outer circumferential direction, by a unit of a second distance which is shorter than the first distance, said drawing method comprising:
a sorting process of performing a sorting processing for sorting drawing data on a plurality of tracks which constitute the desired pattern, by a track unit, in accordance with a direction in which the irradiation position is displaced at least by said second displacing device; and a controlling process of controlling said drawing device to draw the desired pattern on the basis of the sorted drawing data.

7. A computer-readable medium containing a computer program for controlling a computer provided in a drawing apparatus comprising: a drawing device for drawing a desired pattern onto a label surface by applying a laser beam to the label surface provided for a recording medium; a first displacing device for displacing an irradiation position of the applied laser beam in an inner circumferential direction or an outer circumferential direction of the recording medium, by a unit of a first distance; a second displacing device for displacing the irradiation position in the inner circumferential direction or the outer circumferential direction, by a unit of a second distance which is shorter than the first distance; and a sorting device for performing a sorting processing for sorting drawing data on a plurality of tracks which constitute the desired pattern, by a track unit, in accordance with a direction in which the irradiation position is displaced at least by said second displacing device, said computer program making the computer function as at least said sorting device.
